(19) United States
(12) Patent Application Publication
(10) Pub. No.: US 2005/0174436 A1
(43) Pub. Date: Aug. 11, 2005

(54) Photographable multi-function peripheral

(76) Inventor: Peng-Cheng Lai, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/046,833

(22) Filed: Feb. 1, 2005

(30) Foreign Application Priority Data
Feb. 6, 2004 (TW) 93102853

(51) Int. Cl. H04N 5/232

(52) U.S. Cl. 348/211.99

(57) ABSTRACT

The claimed invention discloses a photographable multi-function peripheral that comprises a photography studio including a chamber body having an image capturing device, and an opening designed on surface of the chamber body for placing into an object, a lens of the image capturing device is armed at the object to photograph the object and produce an image; a multi-function peripheral for performing scanning, facsimiling, and printing/duplicating images and a general picture/text that connected with the photography studio via a control device, the control device is used for controlling actions of the photography studio and the multi-function peripheral; and at least one power source for providing power to the photography studio and the multi-function peripheral. The claimed invention effectively integrates the photography studio and the multi-function peripheral, so that can increase the functions of the multi-function peripheral. In addition, the control device is utilized to control the multi-function peripheral and the photography studio, and integrate the computer and display that can effectively condense the space, save the cost, save time of photographing, and produce quality pictures.

### BACKGROUND OF INVENTION

1. Field of the Invention

The invention relates to a Multi-Function Peripheral (MFP), and more particularly, to a photographable MFP.

2. Description of the Prior Art

Cell phones and digital cameras are more and more popular nowadays, and the multi-function peripheral having functions of printing/duplicating, scanning and facsimiling becomes the favorable merchandise in the market. The general multi-function peripheral integrates functions of printing/duplicating, scanning and facsimiling and has the all-in-one feature, so the consumers are willing to accept.

Many businesses utilize the multi-function peripheral to transfer data and communicate with their customers. But they must use the digital camera to photograph products and transfer to their customers via computers when the images of three-dimensional products are required. It takes a long time and is very inconvenient. In addition, the general digital camera cannot have great performance in taking picture of products, and the customers will have more misgiving about the merchandises.

Hence, the present invention discloses a photographable multi-function peripheral to overcome the above-mentioned disadvantages.

### SUMMARY OF INVENTION

It is therefore a primary objective of the claimed invention to provide a photographable multi-function peripheral that integrates the multi-function peripheral and the photography studio to solve the above-mentioned problem that the conventional photostat or multi-function peripheral cannot perform the three-dimensional photographing, editing and network transferring. The claimed invention can increase the functions of the multi-function peripheral.

It is therefore another objective of the claimed invention to provide a photographable multi-function peripheral that can condense the space. The claimed invention utilizes the control device to control the multi-function peripheral and the photography studio, and integrates the computer and display that can effectively condense the space and save the cost.

It is therefore a further objective of the claimed invention to provide a photographable multi-function peripheral that can be extensively used in ways. The claimed invention has functions of photography that can be extensively used in or between businesses to take pictures and communicate each other to save time of photographing and produce quality pictures.

According to the claimed invention, a photographable multi-function peripheral comprises a photography studio including a chamber body having an image capturing device, and an opening designed on surface of the chamber body for placing into an object, a lens of the image capturing device is aimed at the object to photograph the object for producing an image; a multi-function peripheral for performing scanning, facsimiling, and printing/duplicating images for the general picture/text that connected with the photography studio via a control device, the control device is used for controlling the photography studio and the multi-function peripheral; and at least one power source for providing power to the photography studio and the multi-function peripheral.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a detailed block diagram of the present invention.

FIG. 2(a) is a block diagram of the first embodiment according to the present invention.

FIG. 2(b) is a block diagram of the second embodiment according to the present invention.

FIG. 2(c) is a block diagram of the third embodiment according to the present invention.

FIG. 2(d) is a block diagram of the fourth embodiment according to the present invention.

FIG. 2(e) is a block diagram of the fifth embodiment according to the present invention.

| | | | |
|---|---|---|---|
| 10 | photography studio | 102 | image capturing device |
| 104 | object | 106 | light source |
| 108 | ballaster | 112 | photograph controller |
| 20 | multi-function peripheral | 202 | scanning apparatus |
| 204 | facsimiling apparatus | 205 | telephone line |
| 206 | printing/duplicating | 212 | multi-function peripheral |
| | apparatus | | controller |
| 208 | control keypad | 210 | screen |
| 30 | control device | 302 | USB hub |
| 304 | USB | 306 | network cord |
| 40 | power source | | |

### DETAILED DESCRIPTION

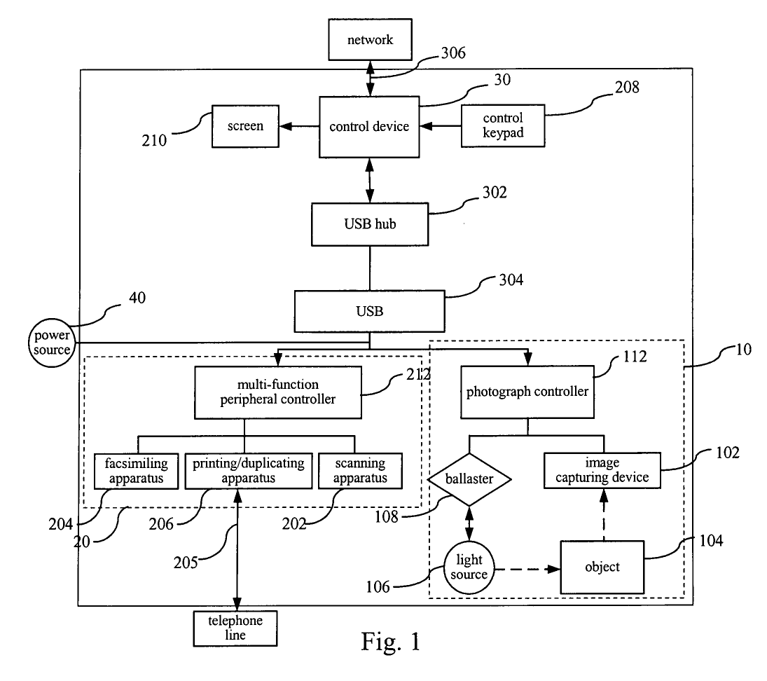

FIG. 1 is a detailed block diagram of the claimed photographable multi-function peripheral. The present invention comprises a photography studio 10 including a chamber body (not shown in figures) that has an image capturing device 102. An opening is designed on surface of the chamber body for placing into an object 104, and a lens of the image capturing device 102 is aimed at the object 104 to photograph the object 104 and produce an image. A multi-function peripheral 20 is connected with the photography studio 10 via a control device 30, and the control device 30 is connected to the photography studio 10 and the multi-function peripheral 20 via a USB hub 302 and a signal transfer cable, which can be a Universal Serial Bus (USB). The control device 30 is used for controlling the photography studio 10 and the multi-function peripheral 20, and the multi-function peripheral 20 comprises the scanning apparatus 202, the facsimiling apparatus 20 and the printing/duplicating apparatus 206 for performing scanning, facsimiling, and printing/duplicating the general picture/text. A telephone line 205 is connected to the facsimiling apparatus 204 for transferring the picture/text. At least one power source 40 provides power to the photography studio 10 and the multi-function peripheral 20.

Wherein, the chamber body further has at least one light source 106 connected to a ballaster 108. The ballaster 108 controls turning on/off the light source 106 via the control device 30, so as to provide the light to the image capturing device 102. The claimed invention further comprises a network cord 306 connecting the control device 30, and the network cord 306 is used for transferring the images and the picture/text through network. The image capturing device 102 is one of general camera, digital camera and video camera, and is installed onto the photography studio 10 by one of embedding type, fixing type and movable type. The multi-function peripheral 20 has a control keypad 208 on its surface or independently from it for controlling actions of the multi-function peripheral 20 to perform scanning, facsimiling, and printing/duplicating the picture/text, and controlling the image capturing device 102. The multi-function peripheral 20 further has a screen 210 on its surface or independently from it for displaying status of the multi-function peripheral 20 and related image capturing data of the image capturing device 102. The control device 30 can be a computer or other controller, the photography studio 10 can have a photograph controller 112 to control the actions of the photography studio 10, and the multi-function peripheral 20 can have a multi-function peripheral controller 212 to control actions of the multi-function peripheral 20.

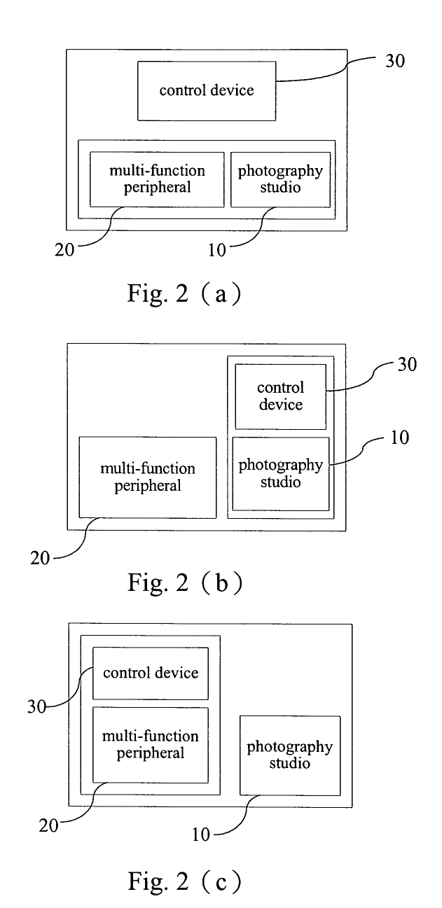

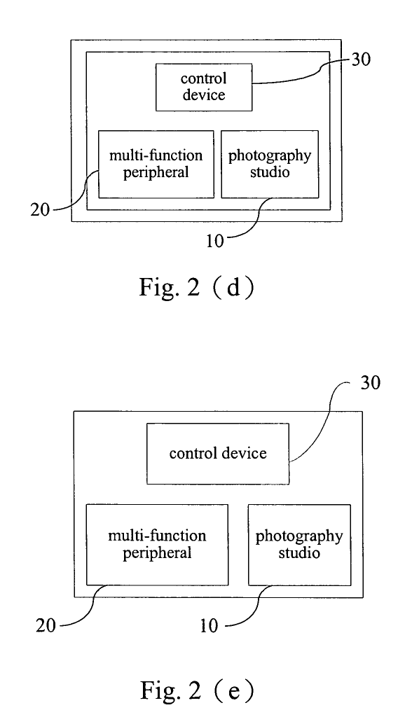

As shown in FIG. 2(a), the control device 30 is independent, and the photography studio 10 is integrated with the multi-function peripheral 20; or as shown in FIG. 2(b), the multi-function peripheral 20 is independent, and the photography studio 10 is integrated with the control device 30; or as shown in FIG. 2(c), the photography studio 10 is independent, and the multi-function peripheral 20 is integrated with the control device 30; or as shown in FIG. 2(d), the photography studio 10, the multi-function peripheral 20 and the control device 30 are all integrated together; or as shown in FIG. 2(e), the photography studio 10, multi-function peripheral 20 and the control device 30 are all separately installed with each other.

The present invention effectively integrates the photography studio, the multi-function peripheral and the control device, so the claimed invention can increase the functions of the multi-function peripheral. In addition, the control device is utilized to control the multi-function peripheral and the photography studio, and integrate the computer and display that can effectively condense the space and save the cost. The claimed invention can be extensively used in or between businesses to take pictures and communicate each other to save time of photographing and produce quality pictures.

Those skilled in the art will readily observe that numerous modifications and alterations of the device may be made while retaining the teachings of the invention. Accordingly, the above disclosure should be construed as limited only by the metes and bounds of the appended claims.

1. A photographable multi-function peripheral, comprising:
a photography studio, including a chamber body having an image capturing device, and an opening designed on surface of the chamber body for placing into an object, a lens of the image capturing device is aimed at the object to be photographed for producing an image;
a multi-function peripheral connected with the photography studio via a control device, the control device is used for controlling the photography studio and the multi-function peripheral, and the multi-function peripheral is used for performing scanning, facsimiling, and printing/duplicating the image and a general picture/text; and
at least one power source for providing power to the photography studio and the multi-function peripheral.

2. The photographable multi-function peripheral of claim 1, wherein the chamber body of the photography studio further has a light source connected to a ballaster, the ballaster controls turning on/off the light source via the control device, so as to provide the light to the image capturing device.

3. The photographable multi-function peripheral of claim 1 further comprising a network cord connecting the control device, the network cord is used for transferring the image and the picture/text through network.

4. The photographable multi-function peripheral of claim 1, wherein the photography studio is integrated with the multi-function peripheral.

5. The photographable multi-function peripheral of claim 1, wherein the photography studio is integrated with the control device.

6. The photographable multi-function peripheral of claim 1, wherein the multi-function peripheral is integrated with the control device.

7. The photographable multi-function peripheral of claim 1, wherein the photography studio is integrated with the multi-function peripheral and the control device.

8. The photographable multi-function peripheral of claim 1, wherein the photography studio, multi-function peripheral and the control device are all separately installed with each other.

9. The photographable multi-function peripheral of claim 1, wherein the image capturing device is one of general camera, digital camera and video camera.

10. The photographable multi-function peripheral of claim 1, wherein the image capturing device is installed onto the photography studio by one of embedding type, fixing type and movable type.

11. The photographable multi-function peripheral of claim 1, wherein the multi-function peripheral is combination of scanning apparatus, facsimiling apparatus and printing/duplicating apparatus for performing scanning, facsimiling, and printing/duplicating the picture/text.

12. The photographable multi-function peripheral of claim 1, wherein surface of the multi-function peripheral has a control keypad for controlling the multi-function peripheral to perform scanning, facsimiling, and printing/duplicating the picture/text, and controlling the image capturing device.

13. The photographable multi-function peripheral of claim 1, wherein a control keypad is designed independently from the multi-function peripheral for controlling the multi-function peripheral to perform scanning, facsimiling, and printing/duplicating the picture/text, and controlling the image capturing device.

14. The photographable multi-function peripheral of claim 1, wherein surface of the multi-function peripheral has a screen for displaying the execution status of the multi-function peripheral and the related image capturing data of the image capturing device.

15. The photographable multi-function peripheral of claim 1, wherein a screen is designed independently from the multi-function peripheral for displaying the execution status of the multi-function peripheral and the related image capturing data of the image capturing device.

16. The photographable multi-function peripheral of claim 1, wherein the control device is selected from the group consisting of computer and other controller.

17. The photographable multi-function peripheral of claim 1, wherein the control device is connected to the photography studio and the multi-function peripheral via a hub and a signal transfer cable.

18. The photographable multi-function peripheral of claim 17, wherein the signal transfer cable is a Universal Serial Bus.

19. The photographable multi-function peripheral of claim 11 further comprising a telephone line connected to the facsimiling apparatus for transferring the picture/text.
